(19) United States
(12) Patent Application Publication
(10) Pub. No.: US 2023/0214559 A1
(43) Pub. Date: Jul. 6, 2023

(54) METHODOLOGY FOR FLUID CHARACTERIZATION OF WIDE RANGE OIL PROPERTIES RESERVOIRS USING LIMITED FLUID DATA

(71) Applicant: Saudi Arabian Oil Company, Dhahran (SA)

(72) Inventors: Hassan Mohammed Alhussain, Dammam (SA); Abdulrahman A. Alsultan, Dhahran (SA)

(21) Appl. No.: 17/569,315

(22) Filed: Jan. 5, 2022

(51) Int. Cl. G06F 30/28

(52) U.S. Cl. CPC G06F 30/28; G06F 2119/02

(57) ABSTRACT

Systems and methods include a computer-implemented method for generating and modeling oil viscosity profiles. An Equation-of-State (EOS) and a field pressure-volumetemperature (PVT) model are generated by reconciling historical well data received for multiple wells in a field of interest. Oil properties trends for checking logical tendencies for in-situ oil composition for local data and at initial conditions are generated using the EOS and the field PVT model, calibrated using measured lab-available oil density, and used to generate an in-situ oil composition for local data and conditions. An oil viscosity profile, generated in the field PVT model based on the oil properties trends, is calibrated and modeled in a two-dimensional PVT model using lab oil viscosity. The two-dimensional PVT model is tested using static and dynamic simulation models in terms of the EOS, compositions, composition gradient, and oil properties, including viscosity.

### TECHNICAL FIELD

The present disclosure applies to determining properties of oil wells.

### BACKGROUND

When sufficient pre-production field pressure-volume-temperature (PVT) data is lacking, in-situ reservoir fluid properties cannot be determined accurately. Additionally, in cases where there are significant changes of fluid properties vertically and/or laterally, the estimation process can become even more complicated. An example of such a case is a heavy oil reservoir with a thick property transition zone (relationship based on depth). In such cases, a simpler black-oil description of the fluid system would not suffice, but rather a detailed compositional characterization is required. Compositional modeling of such systems requires knowledge of in-situ fluid composition, which requires collecting multiple fluid samples. Proper modeling of reservoir fluid properties is important for accurately estimating original volumes of subsurface hydrocarbon accumulation, forecasting production rates, and determining optimal field development strategies.

### SUMMARY

The present disclosure describes techniques that can be used for characterizing wide range oil properties of reservoirs using limited fluid data. In some implementations, a computer-implemented method includes the following. Historical well data is received for multiple wells in a field of interest. An Equation-of-State (EOS) and a field pressure-volume-temperature (PVT) model are generated by reconciling the historical well data. Oil properties trends at initial conditions are generated using the EOS and the field PVT model. The oil properties trends are calibrated using measured lab-available oil density. An in-situ oil composition is generated for local data and conditions using the oil properties trends. Oil properties trends are generated to check logical tendencies for in-situ oil composition for local data and conditions. An oil viscosity profile is generated in the field PVT model based on the oil properties trends. The oil viscosity profile is calibrated and modeled in a two-dimensional PVT model using lab oil viscosity. The two-dimensional PVT model is tested using static and dynamic simulation models in terms of the EOS, compositions, composition gradient, and oil properties, including viscosity.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages.

The techniques of the present disclosure can be effective in producing a reasonable pressure-volume-temperature (PVT) model for a scarce field under uncertainty, which would help a PVT sampling plan significantly. As a result, the techniques can provide cost-effective sampling processes and procedures. Moreover, the techniques can allow testing of the field performance and provide fluid characterization that are a closer match to reality that conventional techniques. The techniques can also help in determining reserve volume and can support decision-making for production development strategies. The significance of these techniques can appear clearly in the reservoir simulation result. For example, FIG. 8 highlights a significant difference in simulation performance between two cases using the same development plan but different PVT models. A methodical approach for obtaining a hydrocarbon PVT model can be used in reservoir simulation. The significance and practicality of the approach can be accomplished even with limited information. For example, in the absence of sufficient pre-production field PVT data, the in-situ oil characterization is uncertain, particularly in significant property gradient cases. Heavy oil reservoirs with thick transition zones are an example. Compositional PVT models are needed, requiring the existence of composition gradients. Knowledge of the in-situ fluid system is important for reserve assessment and recovery estimates. Also, determining the practical/optimum field development strategies in such reservoirs can be challenging. The techniques of the present disclosure provide a structured methodology to complete a practical oil characterization even in data is scarce. Building a reasonable PVT model requires good PVT sampling coverage across the field, vertically and laterally. Techniques of the present disclosure can be used to overcome challenge associate with sampling difficulties in low permeability and heavy oil cases, including providing a structured way to estimate a reliable PVT model.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow diagram showing an example of a workflow for generating a pressure-volume-temperature (PVT) model from limited information, according to some implementations of the present disclosure.

FIG. 2 is a graph showing a synthetic example from a viscosity trend methodology, according to some implementations of the present disclosure.

FIG. 3 is a diagram showing an example of adding characterization (C7+) components to generate composition and match oil densities of deeper oil, according to some implementations of the present disclosure.

FIG. 4 is a graph showing an example mole fraction profile relative to depth for various components used in PVT estimating, according to some implementations of the present disclosure.

FIGS. 5A-5F include graphs showing example plots of different components that are presented relative to depth, according to some implementations of the present disclosure.

FIG. 6 is a graph showing an example of a default liquid-based cytology (LBC) coefficient monotonicity profile, according to some implementations of the present disclosure.

FIG. 7 is a graph showing an example of a viscosity trend match of observed field data, according to some implementations of the present disclosure.

FIGS. 8A-8D are graphs showing examples of plots for a reservoir simulation comparison between a single composition and composition gradient cases, according to some implementations of the present disclosure.

FIG. 9 is a flowchart of an example of a method for characterizing wide range oil properties of reservoirs using limited fluid data, according to some implementations of the present disclosure.

FIG. 10 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for characterizing wide range oil properties of reservoirs using limited fluid data. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The current disclosure describes systematic approaches for generating a detailed compositional pressure-volume-temperature (PVT) simulation in situations in which collected PVT samples are scarce. The approaches can handle changing fluid properties that change with depth. Workflows that are based on the approaches include parameters that can be calibrated as additional field and lab data become available. The techniques can use other sources of data such as derived fluid viscosity logs and industry established correlations to predict fluid compositions.

A methodical approach for obtaining an in-situ PVT model can be used in reservoir simulation. The significance and practicality of this approach is based on the cultivation of limited information. In the absence of sufficient pre-production field PVT data, the in-situ reservoir fluid characterization can be uncertain, particularly in cases where the change in the hydrocarbon property gradient is significant. An example of such a case is a heavy oil reservoir with a thick oil column. Unlike black oil models, a compositional PVT model seems to be more feasible in accurately representing the complex property transition zone. Subsequently, a composition gradient is required for compositional PVT. Knowing the initial hydrocarbon properties is critical for reserve assessment and recovery estimates. Also, determining the practical/optimum field development strategy in such reservoirs can be challenging. The present disclosure describes a structured methodology for providing a practical reservoir fluid characterization when a scarcity of data exists.

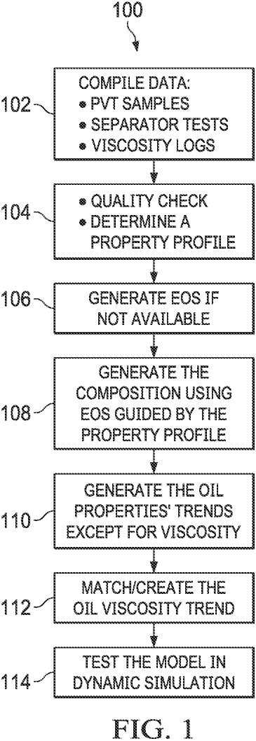

FIG. 1 is a flow diagram showing an example of a workflow 100 for generating a PVT model from limited information, according to some implementations of the present disclosure. Parameters associated with the workflow 100 can be calibrated, corrected, and quality-checked when field or lab data is available for improving accuracy and reliability. The steps of the workflow 100 demonstrate how to generate the PVT model, initially using limited data.

At step 102, data from a field of interest is compiled. The main pieces of information are PVT analyses, deliverability test data, and viscosity logs. This data is important for the following reasons. PVT analysis is needed to generate equations of state (EOS). Condensate gas ratio / gas-oil rate (CGR/GOR), API, or specific gravity from the deliverability test is required and to be used as a matching parameter during the process and/or generate EOS if no PVT samples available. Viscosity logs, in the case of oil reservoirs, can be used to create the property transition zone property and composition trends in cases in which PVT samples are absent. Oil density can be calculated from viscosity and used as a matching parameter.

At 104, a quality check is performed on the data. The quality check can be used to determine property gradients with depth, x-offset, or y-offsets.

At 106, two potential scenarios regarding EOD data are possible. In a first scenario, a single composition is observed or expected where the hydrocarbon properties are similar across the reservoir, vertically and laterally. Ideally, a PVT sample is collected, and a full PVT study is conducted. If a CGR/GOR, American Petroleum Institute gravity (API), or specific gravity is available, then the PVT model (EOS or black oil table) is generated. In a second scenario, in the case in which the composition gradient is observed with a lack of PVT sampling, it is recommended that a PVT model is generated.

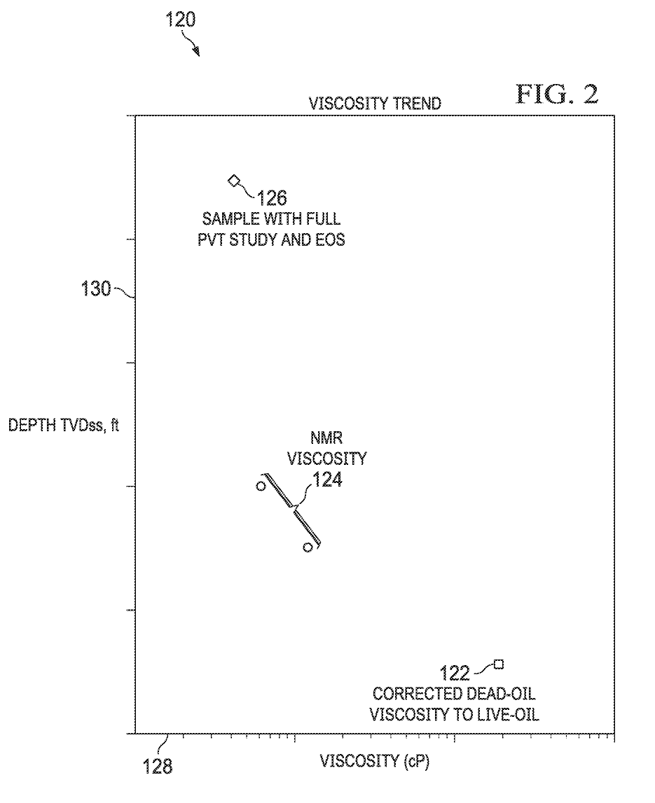

FIG. 2 is a graph 120 showing a synthetic example from a viscosity trend methodology, according to some implementations of the present disclosure. In this example, the reservoir possesses one PVT sample 122 with its EOS at a shallow depth, two nuclear magnetic resonance (NMR) viscosity points 124 indicating a transition zone, and one data point 126 of dead oil viscosity information. The points 122, 124, and 126 are plotted relative to a viscosity axis 128 (e.g., in Centipoise (cP)) and a depth axis 130 (e.g., as a true vertical depth measured from mean sea level (TVDSS), in feet).

In the second scenario introduced previously, the workflow 100 can start from step 108. Matching data can be calculated within the EOS, such as using GOR and saturation pressure. In an example, a heavy oil reservoir with two wells having oil samples can be assumed, with the first well being shallow and yielding a comprehensive set of data, and the second well being deep with a dead oil viscosity at reservoir temperature. In this case, NMR-viscosity can be utilized, resulting in a property transition zone. The reason for assuming NMR-viscosity is because open-hole (OH) logs are typically the first information that is collected after drilling. Down-hole samples are not able to be collected sometimes because of operational issues. Sampling heavy oil is generally challenging and extremely difficult from low permeability rock. Surface samples may not be possible because of environmental reasons or proximity to populated areas. The dead oil sample (with an analog availability) is assumed here to show such usage of information which engineers sometimes ignore.

At 108, the composition trend is simulated to match the viscosity profile in this example. This step reflects the main purpose of the workflow 100, which is to generate a PVT model that reasonably characterizes the in-situ fluid system. Note that viscosity is not calculated within EOS. Therefore, another parameter is needed that is based on oil viscosity and that can be calculated via EOS. Industry available correlation techniques can be used to estimate oil density from viscosity. The calculated oil density can be calibrated with PVT lab experiments from a nearby analogous field, if available:

$$ln \left(μ \text{} \text{ob}\right) = - 2.652294 + 8.484462 {\left(\text{ρ} \text{ob}\right)}^{4}$$

where µob is the oil viscosity at bubble point and ρob is oil density at bubble point. Although the correlation in Equation (1) considers bubble-point pressure properties, some literature on the subject of phase behavior indicates that the equation can be applied in under-saturated and saturated conditions.

Calibrating the available information is important for the uncertainty mitigation. NMR-viscosity can be adjusted using PVT-viscosity, if available. If discrepancies exist between NMR- and PVT-viscosity, the NMR-viscosity reading can be corrected for that field of interest. In some implementations, a viscosity plot can include NMR viscosity calibration determined using a lab oil sample. In some implementations, oil samples can be plotted relative to:

$$\frac{\text{VHO + VMO}}{\text{VHO + VMO + VLO}}$$

where VHO is heavy oil volume, VMO is medium oil volume, and VLO is light oil volume, plotted relative to a live oil viscosity axis (e.g., in cP). NMR tool calculations can be calibrated, for example, using PVT-viscosity techniques (e.g., Hursan et al., 2016).

Another important point is that if a dead oil viscosity is available, it can be corrected to the in-situ condition by knowing the GOR and reservoir pressure and temperature. The PVT model must be at reservoir condition. A Chew-Connally correlation can be utilized for this purpose, for example, using:

$${μ}_{\text{ob}} = {\text{A}}_{1} {\left({μ}_{\text{od}}\right)}^{{\text{A}}_{2}}$$

where µob is the oil viscosity at bubble point, µ_{od} is the dead oil viscosity, and A₁ and A₂ are best-fit correlations.

At 110, after establishing the property profile, the composition can be generated utilizing a commercial PVT package (e.g., PhazeComp of Zick Technologies). This step involves iterations of adding characterization (C7+) pseudo-components to the available sample. The proportion of the C7+ pseudo-components can be same, but the number of moles can differ in each iteration. PhazeComp can be used, for example, to calculate lighter components automatically. The benchmark is matching the properties determined in step 108; the matched property is oil density in this example.

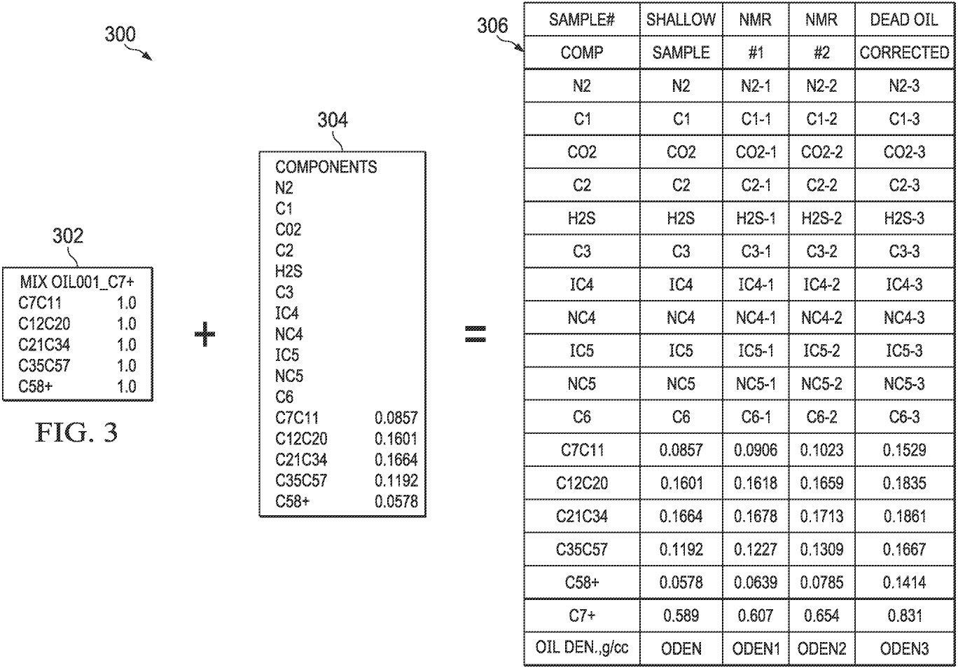

FIG. 3 is a diagram showing an example of adding C7+ components to generate composition and match oil densities of deeper oil, according to some implementations of the present disclosure. For example, components 302 can be added to (or combined with) components 304 to generate a table 306.

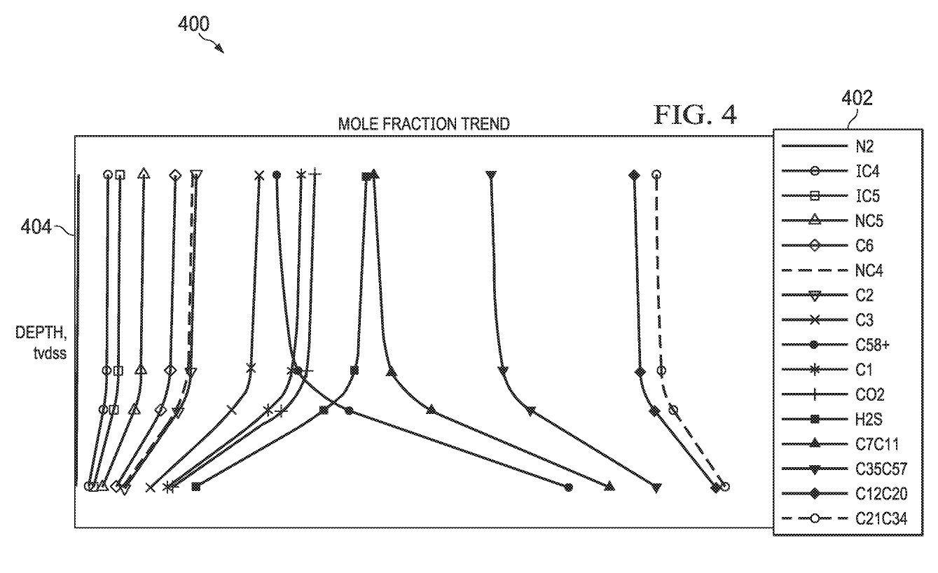

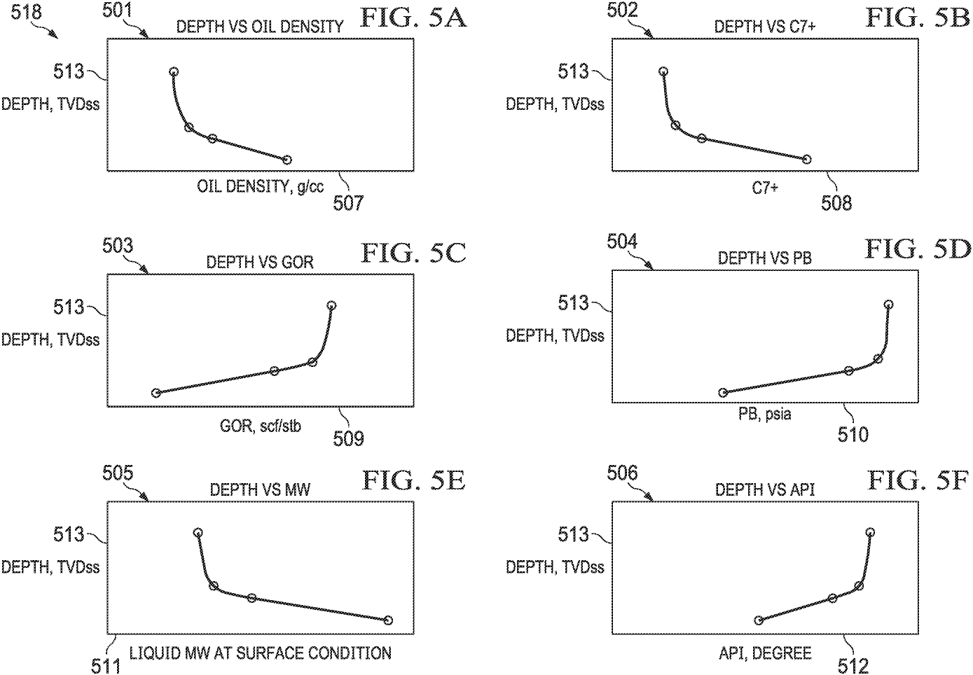

At 112, simulated composition, oil density, C7+ composition, GOR, saturation pressure, molecular weight, and API are to be plotted. FIG. 4 is a graph 400 showing an example mole fraction profile (or trend) relative to depth 404 for various components 402 used in PVT estimating, according to some implementations of the present disclosure. FIGS. 5A-5F include graphs showing example plots 501-506 of different components that are presented relative to depth, according to some implementations of the present disclosure. Together, the plots 501-506 include oil properties profiles and show logical trends. Plot 501 plots oil density 507 (e.g., in grams per cubic centimeter (g/cc)) relative to depth 513 (e.g., TVDSS in feet). Plot 502 plots c7+ 508 relative to depth 513. Plot 503 plots GOR 509 (e.g., in standard cubic feet/standard daily barrels (scf/stb)) relative to depth 513. Plot 504 plots Pb 510 (e.g., in pounds per square inch (psia)) relative to depth 513. Plot 505 plots liquid molecular weight (Mw) at surface condition 511 (e.g., a numeric value) relative to depth 513. Plot 506 plots API 512 (e.g., in degrees) relative to depth 513. When used together, FIGS. 4 and 5A-5F can be used to check the consistency and monotonicity.

At 114, viscosity is to be modeled, e.g., by commercial reservoir simulators such as a Lohrenz-Bray-Clark (LBC) correlation for viscosity calculation. In this case, viscosity can be calculated out of EOS. It is recommended to follow industry-known procedures for LBC viscosity correlation for gas condensate reservoir and viscosity modeling. It is recommended to avoid altering the default liquid-based cytology (LBC) parameters used throughout the processes unless it is otherwise impossible to match viscosity using the parameters as is. In some implementations, the PVT packages can use the following LBC parameters as a default:

$$\text{P0 = 0} \text{.1023}$$

$$\text{P1 = 0} \text{.023364}$$

$$\text{P2 = 0} \text{.058533}$$

$$\text{P3 = -0} \text{.040758}$$

$$\text{P4 = 0} \text{.0093324}$$

$$\text{F0 = 0} \text{.1}$$

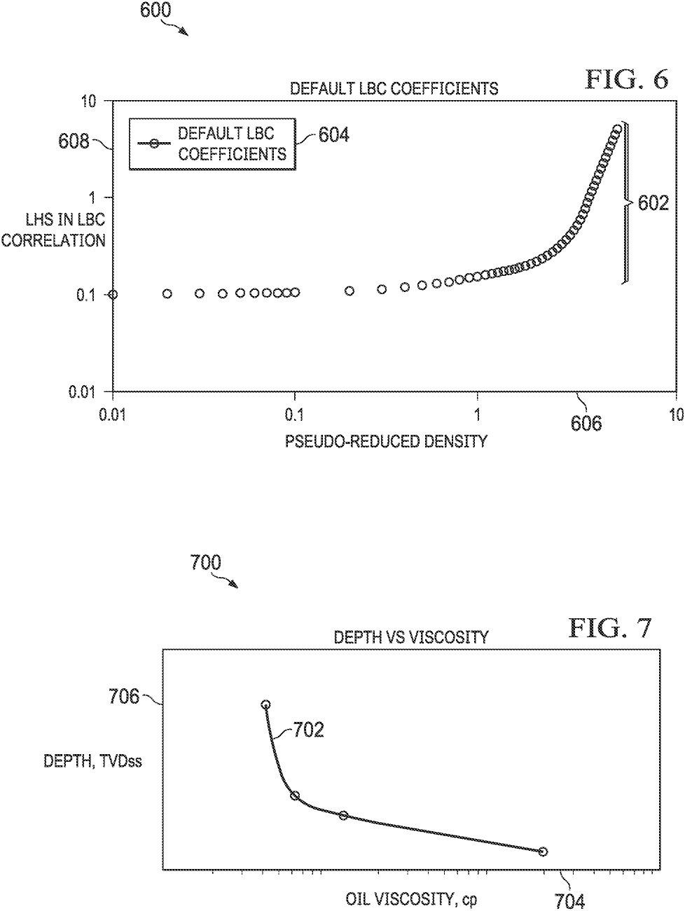

In case there is a need to alter the LBC parameters, the monotonicity of LBC correlation can be checked against the pseudo-reduced density each time a parameter is changed. It is recommended that the parameters be similar to values in the default LBC coefficients plot relative to FIG. 6.

FIG. 6 is a graph showing an example of a default LBC coefficient monotonicity profile 602, according to some implementations of the present disclosure. Points in the profile 602 are based on the use of default LBC coefficients 604. The profile 602 is plotted relative to a pseudo-reduced density (ppr) axis 606 and a left-hand side (LHS), where:

$${\text{LHS = P0 + P1*ppr + P2*prr}}^{2} {\text{+ P3*prr}}^{3} {\text{+ P4*ppr}}^{4}$$

in LBC correlation 608. The viscosity can be plotted (FIG. 7) as a check for trend smoothness (FIG. 6).

FIG. 7 is a graph 700 showing an example of a viscosity trend match of observed field data, according to some implementations of the present disclosure. The graph 700 includes a plot 702 that is plotted relative to an oil viscosity axis 704 (e.g., in cP) and a depth axis 706 (e.g., TVDSS).

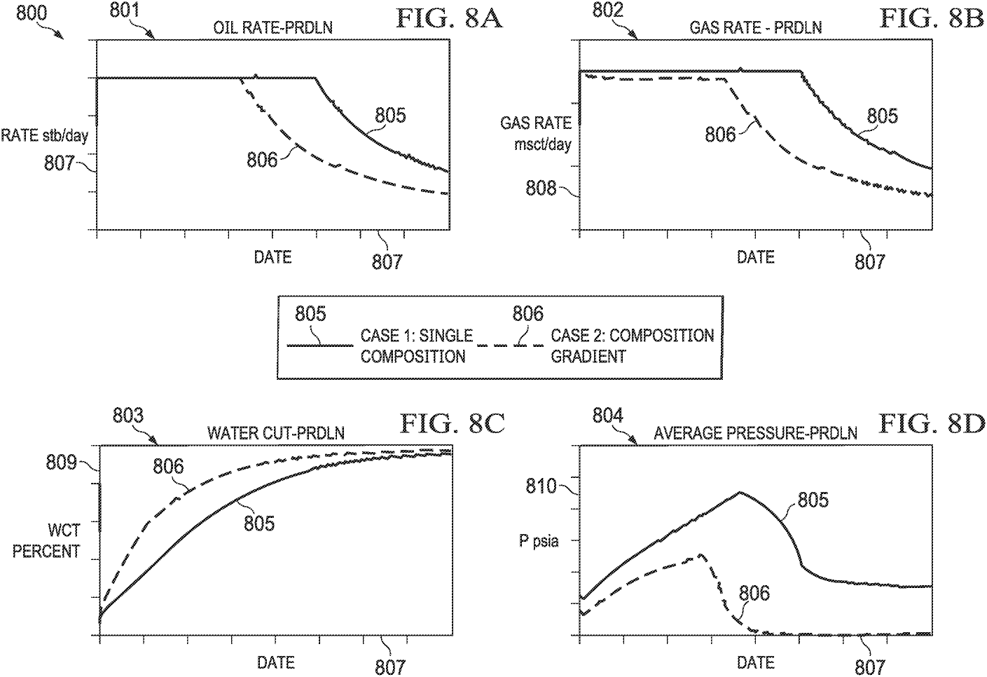

FIGS. 8A-8D are graphs 801-804 showing examples of plots for a reservoir simulation comparison between a single composition 805 and composition gradient 806 cases, according to some implementations of the present disclosure. The plots of the graphs 801-804 are plotted relative to a date axis 807. An oil rate plot in graph 801 is plotted relative to a production rate 807 (e.g., in std/day). A gas rate plot in graph 802 is plotted relative to a gas rate 808 (e.g., thousands of standard cubic feet per day). A water cut plot in graph 803 is plotted relative to a water cut percentage 809. An average pressure plot in graph 804 is plotted relative to a pressure 810 (e.g., in psia). The plots 801-804 highlight a significant difference in simulation performance between two cases using the same development plan but different PVT models.

In the single composition 805 scenario, a single PVT composition of the shallow sample is assumed. This case has a longer oil production plateau, less water cut, and a higher average reservoir pressure. This combination shows the importance of good PVT sampling coverage. In order to minimize the uncertainty and avoid costs of unnecessary sampling operations and subsequent lab tests, the properties profile can be used as guidance to select the sampling location. In the composition gradient 806 scenario, the compositional gradient as an outcome is used.

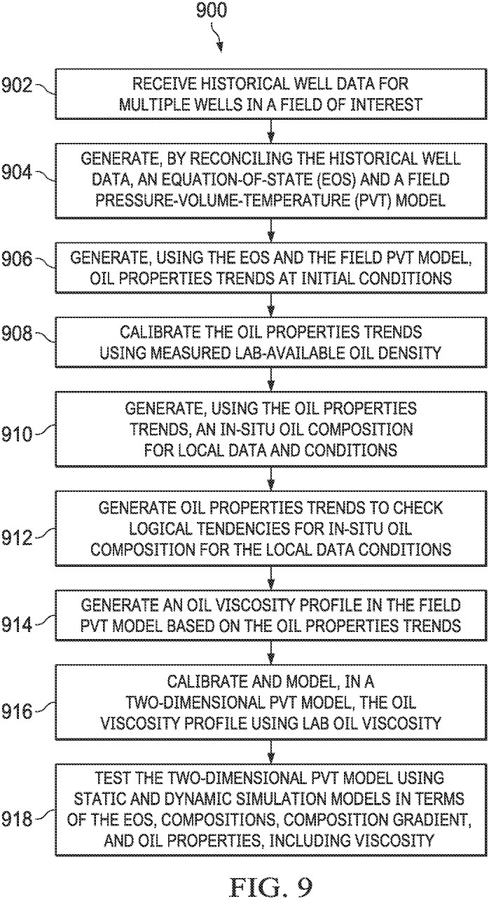

FIG. 9 is a flowchart of an example of a method 900 for characterizing wide range oil properties of reservoirs using limited fluid data, according to some implementations of the present disclosure. For clarity of presentation, the description that follows generally describes method 900 in the context of the other figures in this description. However, it will be understood that method 900 can be performed, for example, by any suitable system, environment, software, and hardware, or a combination of systems, environments, software, and hardware, as appropriate. In some implementations, various steps of method 900 can be run in parallel, in combination, in loops, or in any order.

At 902, historical well data is received for multiple wells in a field of interest. As an example, the historical well data can include PVT analyses, deliverability tests, and viscosity logs for each well for which data is available. From 902, method 900 proceeds to 904.

At 904, an Equation-of-State (EOS) and a field pressure-volume-temperature (PVT) model are generated by reconciling the historical well data. Reconciliation can include, for example, correlating the different types of data, including pressure, volume, and temperature data over time. From 904, method 900 proceeds to 906.

At 906, oil properties trends at initial conditions are generated using the EOS and the field PVT model. For example, generating oil properties trends can include generating oil properties trends for density, gas-oil ratio (GOR), saturation pressure, C7+ mole, characterization (C7+), molecular weight (MW), and American Petroleum Institute gravity (API). From 906, method 900 proceeds to 908.

At 908, the oil properties trends are calibrated using measured lab-available oil density. For example, using existing measured data, when available, the trends can be adjusted. From 908, method 900 proceeds to 910.

At 910, an in-situ oil composition is generated for local data and conditions using the oil properties trends. The in-situ oil composition corresponds to estimates of oil composition for the location of a particular well to be drilled. From 910, method 900 proceeds to 912.

At 912, oil properties trends are generated to check logical tendencies for in-situ oil composition for local data and conditions. For example, the oil properties trends can be based on density, GOR, saturation pressure, and lab and log oil viscosity starting at the initial conditions. The oil properties trends can be determined based on published correlations. From 912, method 900 proceeds to 914.

At 914, an oil viscosity profile is generated in the field PVT model based on the oil properties trends. From 914, method 900 proceeds to 916.

At 916, the oil viscosity profile is calibrated and modeled in a two-dimensional PVT model using lab oil viscosity. Calibrating the oil properties trends can include applying a magnitude of correction to calculated values based on differences between the calculated values and measured values. The calculated values can be plotted against the measured ones (if available) in order to apply the magnitude of correction. From 910, method 900 proceeds to 918.

At 918, the two-dimensional PVT model is tested using static and dynamic simulation models in terms of the EOS, compositions, composition gradient, and oil properties, including viscosity. For example, the whole PVT system that led to the field performance at 800 can be tested. After 918, method 900 can stop.

In some implementations, method 900 further includes performing a quality check the historical well data for accuracy and reliability. For example, the field and lab reports can be reviewed in order to make sure that test/experiments were conducted properly.

In some implementations, in addition to (or in combination with) any previously-described features, techniques of the present disclosure can include the following. Customized user interfaces can present intermediate or final results of the above described processes to a user. The presented information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change or an improvement in drilling parameters (including speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

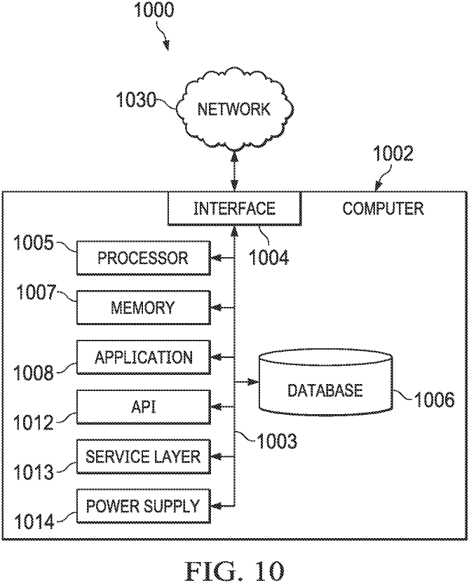

FIG. 10 is a block diagram of an example computer system 1000 used to provide computational functionalities associated with described algorithms, methods, functions, processes, flows, and procedures described in the present disclosure, according to some implementations of the present disclosure. The illustrated computer 1002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1002 can include input devices such as keypads, keyboards, and touch screens that can accept user information. Also, the computer 1002 can include output devices that can convey information associated with the operation of the computer 1002. The information can include digital data, visual data, audio information, or a combination of information. The information can be presented in a graphical user interface (UI) (or GUI).

The computer 1002 can serve in a role as a client, a network component, a server, a database, a persistency, or components of a computer system for performing the subject matter described in the present disclosure. The illustrated computer 1002 is communicably coupled with a network 1030. In some implementations, one or more components of the computer 1002 can be configured to operate within different environments, including cloud-computing-based environments, local environments, global environments, and combinations of environments.

At a top level, the computer 1002 is an electronic computing device operable to receive, transmit, process, store, and manage data and information associated with the described subject matter. According to some implementations, the computer 1002 can also include, or be communicably coupled with, an application server, an email server, a web server, a caching server, a streaming data server, or a combination of servers.

The computer 1002 can receive requests over network 1030 from a client application (for example, executing on another computer 1002). The computer 1002 can respond to the received requests by processing the received requests using software applications. Requests can also be sent to the computer 1002 from internal users (for example, from a command console), external (or third) parties, automated applications, entities, individuals, systems, and computers.

Each of the components of the computer 1002 can communicate using a system bus 1003. In some implementations, any or all of the components of the computer 1002, including hardware or software components, can interface with each other or the interface 1004 (or a combination of both) over the system bus 1003. Interfaces can use an application programming interface (API) 1012, a service layer 1013, or a combination of the API 1012 and service layer 1013. The API 1012 can include specifications for routines, data structures, and object classes. The API 1012 can be either computer-language independent or dependent. The API 1012 can refer to a complete interface, a single function, or a set of APIs.

The service layer 1013 can provide software services to the computer 1002 and other components (whether illustrated or not) that are communicably coupled to the computer 1002. The functionality of the computer 1002 can be accessible for all service consumers using this service layer. Software services, such as those provided by the service layer 1013, can provide reusable, defined functionalities through a defined interface. For example, the interface can be software written in JAVA, C++, or a language providing data in extensible markup language (XML) format. While illustrated as an integrated component of the computer 1002, in alternative implementations, the API 1012 or the service layer 1013 can be stand-alone components in relation to other components of the computer 1002 and other components communicably coupled to the computer 1002. Moreover, any or all parts of the API 1012 or the service layer 1013 can be implemented as child or sub-modules of another software module, enterprise application, or hardware module without departing from the scope of the present disclosure.

The computer 1002 includes an interface 1004. Although illustrated as a single interface 1004 in FIG. 10, two or more interfaces 1004 can be used according to particular needs, desires, or particular implementations of the computer 1002 and the described functionality. The interface 1004 can be used by the computer 1002 for communicating with other systems that are connected to the network 1030 (whether illustrated or not) in a distributed environment. Generally, the interface 1004 can include, or be implemented using, logic encoded in software or hardware (or a combination of software and hardware) operable to communicate with the network 1030. More specifically, the interface 1004 can include software supporting one or more communication protocols associated with communications. As such, the network 1030 or the interface’s hardware can be operable to communicate physical signals within and outside of the illustrated computer 1002.

The computer 1002 includes a processor 1005. Although illustrated as a single processor 1005 in FIG. 10, two or more processors 1005 can be used according to particular needs, desires, or particular implementations of the computer 1002 and the described functionality. Generally, the processor 1005 can execute instructions and can manipulate data to perform the operations of the computer 1002, including operations using algorithms, methods, functions, processes, flows, and procedures as described in the present disclosure.

The computer 1002 also includes a database 1006 that can hold data for the computer 1002 and other components connected to the network 1030 (whether illustrated or not). For example, database 1006 can be an in-memory, conventional, or a database storing data consistent with the present disclosure. In some implementations, database 1006 can be a combination of two or more different database types (for example, hybrid in-memory and conventional databases) according to particular needs, desires, or particular implementations of the computer 1002 and the described functionality. Although illustrated as a single database 1006 in FIG. 10, two or more databases (of the same, different, or combination of types) can be used according to particular needs, desires, or particular implementations of the computer 1002 and the described functionality. While database 1006 is illustrated as an internal component of the computer 1002, in alternative implementations, database 1006 can be external to the computer 1002.

The computer 1002 also includes a memory 1007 that can hold data for the computer 1002 or a combination of components connected to the network 1030 (whether illustrated or not). Memory 1007 can store any data consistent with the present disclosure. In some implementations, memory 1007 can be a combination of two or more different types of memory (for example, a combination of semiconductor and magnetic storage) according to particular needs, desires, or particular implementations of the computer 1002 and the described functionality. Although illustrated as a single memory 1007 in FIG. 10, two or more memories 1007 (of the same, different, or combination of types) can be used according to particular needs, desires, or particular implementations of the computer 1002 and the described functionality. While memory 1007 is illustrated as an internal component of the computer 1002, in alternative implementations, memory 1007 can be external to the computer 1002.

The application 1008 can be an algorithmic software engine providing functionality according to particular needs, desires, or particular implementations of the computer 1002 and the described functionality. For example, application 1008 can serve as one or more components, modules, or applications. Further, although illustrated as a single application 1008, the application 1008 can be implemented as multiple applications 1008 on the computer 1002. In addition, although illustrated as internal to the computer 1002, in alternative implementations, the application 1008 can be external to the computer 1002.

The computer 1002 can also include a power supply 1014. The power supply 1014 can include a rechargeable or non-rechargeable battery that can be configured to be either user- or non-user-replaceable. In some implementations, the power supply 1014 can include power-conversion and management circuits, including recharging, standby, and power management functionalities. In some implementations, the power-supply 1014 can include a power plug to allow the computer 1002 to be plugged into a wall socket or a power source to, for example, power the computer 1002 or recharge a rechargeable battery.

There can be any number of computers 1002 associated with, or external to, a computer system containing computer 1002, with each computer 1002 communicating over network 1030. Further, the terms “client,” “user,” and other appropriate terminology can be used interchangeably, as appropriate, without departing from the scope of the present disclosure. Moreover, the present disclosure contemplates that many users can use one computer 1002 and one user can use multiple computers 1002.

Described implementations of the subject matter can include one or more features, alone or in combination.

For example, in a first implementation, a computer-implemented method includes the following. Historical well data is received for multiple wells in a field of interest. An Equation-of-State (EOS) and a field pressure-volume-temperature (PVT) model are generated by reconciling the historical well data. Oil properties trends at initial conditions are generated using the EOS and the field PVT model. The oil properties trends are calibrated using measured lab-available oil density. An in-situ oil composition is generated for local data and conditions using the oil properties trends. Oil properties trends are generated to check logical tendencies for in-situ oil composition for local data and conditions. An oil viscosity profile is generated in the field PVT model based on the oil properties trends. The oil viscosity profile is calibrated and modeled in a two-dimensional PVT model using lab oil viscosity. The two-dimensional PVT model is tested using static and dynamic simulation models in terms of the EOS, compositions, composition gradient, and oil properties, including viscosity.

The foregoing and other described implementations can each, optionally, include one or more of the following features:

A first feature, combinable with any of the following features, the method further including performing a quality check the historical well data for accuracy and reliability.

A second feature, combinable with any of the previous or following features, where the historical well data includes PVT analyses, deliverability tests, and viscosity logs for each well for which data is available.

A third feature, combinable with any of the previous or following features, where the oil properties trends are based on density, GOR, saturation pressure, and lab and log oil viscosity starting at the initial conditions.

A fourth feature, combinable with any of the previous or following features, where the oil properties trends are based on published correlations.

A fifth feature, combinable with any of the previous or following features, where testing the oil viscosity profile in the static and dynamic simulation models includes modeling and checking, statically and dynamically, the oil viscosity profile in a three-dimensional model.

A sixth feature, combinable with any of the previous or following features, where calibrating the oil properties trends includes applying a magnitude of correction to calculated values based on differences between the calculated values and measured values.

A seventh feature, combinable with any of the previous or following features, where generating oil properties trends includes generating oil properties trends for density, gas-oil ratio (GOR), saturation pressure, C7+ mole, characterization (C7+), molecular weight (MW), and American Petroleum Institute gravity (API).

In a second implementation, a non-transitory, computer-readable medium stores one or more instructions executable by a computer system to perform operations including the following. Historical well data is received for multiple wells in a field of interest. An Equation-of-State (EOS) and a field pressure-volume-temperature (PVT) model are generated by reconciling the historical well data. Oil properties trends at initial conditions are generated using the EOS and the field PVT model. The oil properties trends are calibrated using measured lab-available oil density. An in-situ oil composition is generated for local data and conditions using the oil properties trends. Oil properties trends are generated to check logical tendencies for in-situ oil composition for local data and conditions. An oil viscosity profile is generated in the field PVT model based on the oil properties trends. The oil viscosity profile is calibrated and modeled in a two-dimensional PVT model using lab oil viscosity. The two-dimensional PVT model is tested using static and dynamic simulation models in terms of the EOS, compositions, composition gradient, and oil properties, including viscosity.

The foregoing and other described implementations can each, optionally, include one or more of the following features:

A first feature, combinable with any of the following features, the operations further including performing a quality check the historical well data for accuracy and reliability.

A second feature, combinable with any of the previous or following features, where the historical well data includes PVT analyses, deliverability tests, and viscosity logs for each well for which data is available.

A third feature, combinable with any of the previous or following features, where the oil properties trends are based on density, GOR, saturation pressure, and lab and log oil viscosity starting at the initial conditions.

A fourth feature, combinable with any of the previous or following features, where the oil properties trends are based on published correlations.

A fifth feature, combinable with any of the previous or following features, where testing the oil viscosity profile in the static and dynamic simulation models includes modeling and checking, statically and dynamically, the oil viscosity profile in a three-dimensional model.

A sixth feature, combinable with any of the previous or following features, where calibrating the oil properties trends includes applying a magnitude of correction to calculated values based on differences between the calculated values and measured values.

A seventh feature, combinable with any of the previous or following features, where generating oil properties trends includes generating oil properties trends for density, gas-oil ratio (GOR), saturation pressure, C7+ mole, characterization (C7+), molecular weight (MW), and American Petroleum Institute gravity (API).

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. Historical well data is received for multiple wells in a field of interest. An Equation-of-State (EOS) and a field pressure-volume-temperature (PVT) model are generated by reconciling the historical well data. Oil properties trends at initial conditions are generated using the EOS and the field PVT model. The oil properties trends are calibrated using measured lab-available oil density. An in-situ oil composition is generated for local data and conditions using the oil properties trends. Oil properties trends are generated to check logical tendencies for in-situ oil composition for local data and conditions. An oil viscosity profile is generated in the field PVT model based on the oil properties trends. The oil viscosity profile is calibrated and modeled in a two-dimensional PVT model using lab oil viscosity. The two-dimensional PVT model is tested using static and dynamic simulation models in terms of the EOS, compositions, composition gradient, and oil properties, including viscosity.

The foregoing and other described implementations can each, optionally, include one or more of the following features:

A first feature, combinable with any of the following features, the operations further including performing a quality check the historical well data for accuracy and reliability.

A second feature, combinable with any of the previous or following features, where the historical well data includes PVT analyses, deliverability tests, and viscosity logs for each well for which data is available.

A third feature, combinable with any of the previous or following features, where the oil properties trends are based on density, GOR, saturation pressure, and lab and log oil viscosity starting at the initial conditions.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user’s client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving historical well data for multiple wells in a field of interest;
generating, by reconciling the historical well data, an Equation-of-State (EOS) and a field pressure-volume-temperature (PVT) model;
generating, using the EOS and the field PVT model, oil properties trends at initial conditions;
calibrating the oil properties trends using measured lab-available oil density;
generating, using the oil properties trends, an in-situ oil composition for local data and conditions;
generating oil properties trends to check logical tendencies for in-situ oil composition for local data and conditions;
generating an oil viscosity profile in the field PVT model based on the oil properties trends;
calibrating and modeling, in a two-dimensional PVT model, the oil viscosity profile using lab oil viscosity; and
testing the two-dimensional PVT model using static and dynamic simulation models in terms of the EOS, compositions, composition gradient, and oil properties, including viscosity.

2. The computer-implemented method of claim 1, further comprising:
performing a quality check the historical well data for accuracy and reliability.

3. The computer-implemented method of claim 1, wherein the historical well data includes PVT analyses, deliverability tests, and viscosity logs for each well for which data is available.

4. The computer-implemented method of claim 1, wherein the oil properties trends are based on density, GOR, saturation pressure, and lab and log oil viscosity starting at the initial conditions.

5. The computer-implemented method of claim 4, wherein the oil properties trends are based on published correlations.

6. The computer-implemented method of claim 1, wherein testing the oil viscosity profile in the static and dynamic simulation models includes modeling and checking, statically and dynamically, the oil viscosity profile in a three-dimensional model.

7. The computer-implemented method of claim 1, wherein calibrating the oil properties trends includes applying a magnitude of correction to calculated values based on differences between the calculated values and measured values.

8. The computer-implemented method of claim 1, wherein generating oil properties trends includes generating oil properties trends for density, gas-oil ratio (GOR), saturation pressure, C7+ mole, characterization (C7+), molecular weight (MW), and American Petroleum Institute gravity (API).

9. A non-transitory, computer-readable medium storing one or more instructions executable by a computer system to perform operations comprising:
receiving historical well data for multiple wells in a field of interest;
generating, by reconciling the historical well data, an Equation-of-State (EOS) and a field pressure-volume-temperature (PVT) model;
generating, using the EOS and the field PVT model, oil properties trends at initial conditions;
calibrating the oil properties trends using measured lab-available oil density;
generating, using the oil properties trends, an in-situ oil composition for local data and conditions;
generating oil properties trends to check logical tendencies for in-situ oil composition for local data and conditions;
generating an oil viscosity profile in the field PVT model based on the oil properties trends;
calibrating and modeling, in a two-dimensional PVT model, the oil viscosity profile using lab oil viscosity; and
testing the two-dimensional PVT model using static and dynamic simulation models in terms of the EOS, compositions, composition gradient, and oil properties, including viscosity.

10. The non-transitory, computer-readable medium of claim 9, the operations further comprising: performing a quality check the historical well data for accuracy and reliability.

11. The non-transitory, computer-readable medium of claim 9, wherein the historical well data includes PVT analyses, deliverability tests, and viscosity logs for each well for which data is available.

12. The non-transitory, computer-readable medium of claim 9, wherein the oil properties trends are based on density, GOR, saturation pressure, and lab and log oil viscosity starting at the initial conditions.

13. The non-transitory, computer-readable medium of claim 12, wherein the oil properties trends are based on published correlations.

14. The non-transitory, computer-readable medium of claim 9, wherein testing the oil viscosity profile in the static and dynamic simulation models includes modeling and checking, statically and dynamically, the oil viscosity profile in a three-dimensional model.

15. The non-transitory, computer-readable medium of claim 9, wherein calibrating the oil properties trends includes applying a magnitude of correction to calculated values based on differences between the calculated values and measured values.

16. The non-transitory, computer-readable medium of claim 9, wherein generating oil properties trends includes generating oil properties trends for density, gas-oil ratio (GOR), saturation pressure, C7+ mole, characterization (C7+), molecular weight (MW), and American Petroleum Institute gravity (API).

17. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving historical well data for multiple wells in a field of interest;
generating, by reconciling the historical well data, an Equation-of-State (EOS) and a field pressure-volume-temperature (PVT) model;
generating, using the EOS and the field PVT model, oil properties trends at initial conditions;
calibrating the oil properties trends using measured lab-available oil density;
generating, using the oil properties trends, an in-situ oil composition for local data and conditions;
generating oil properties trends to check logical tendencies for in-situ oil composition for local data and conditions;
generating an oil viscosity profile in the field PVT model based on the oil properties trends;
calibrating and modeling, in a two-dimensional PVT model, the oil viscosity profile using lab oil viscosity; and
testing the two-dimensional PVT model using static and dynamic simulation models in terms of the EOS, compositions, composition gradient, and oil properties, including viscosity.

18. The computer-implemented system of claim 17, the operations further comprising: performing a quality check the historical well data for accuracy and reliability.

19. The computer-implemented system of claim 17, wherein the historical well data includes PVT analyses, deliverability tests, and viscosity logs for each well for which data is available.

20. The computer-implemented system of claim 17, wherein the oil properties trends are based on density, GOR, saturation pressure, and lab and log oil viscosity starting at the initial conditions.
